(19) United States
(12) Patent Application Publication
(10) Pub. No.: US 2012/0092116 A1
(43) Pub. Date: Apr. 19, 2012

(54) HIGH VOLTAGE TRANSFORMER

(75) Inventors: CHIH-CHAN GER, Jhongli City (TW); YU-SHENG TAO, Jhongli City (TW); LIEN-FU CHIEN, Jhongli City (TW)

(73) Assignee: AMPOWER TECHNOLOGY CO., LTD., Jhongli City (TW)

(21) Appl. No.: 12/965,925

(22) Filed: Dec. 13, 2010

(30) Foreign Application Priority Data
Oct. 15, 2010 (CN) 201020564668.6

(51) Int. Cl. H01F 27/28

(52) U.S. Cl. 336/171

(57) ABSTRACT

A high voltage transformer includes a first core and a second core coupled to the first core. The first core includes a protruding portion isolating the second core into a first winding portion and a second winding portion. The first winding portion is wrapped by a first primary winding and a first secondary winding to define a first magnetic circuit, and the second winding portion is wrapped by a second primary winding and a second secondary winding to define a second magnetic circuit. Direction of the first magnetic circuit is reversed to that of the second magnetic circuit. Width of the protruding portion is adjustable to achieve different leakage inductances between the first secondary winding and the second secondary winding, so as to balance current flowing through the first secondary winding and the second secondary winding.

### BACKGROUND

1. Technical Field

The present disclosure relates to a high voltage transformer, and more particularly to the high-voltage transformer for balancing current.

2. Description of Related Art

Referring to FIG. 5, a commonly used high voltage transformer 20 is shown. The high voltage transformer 20 comprises a pair of magnetic cores 22 configured in an E shape. The pair of magnetic cores 22 are arranged face to face and each comprises winding cores 221 in middle of the pair of magnetic cores 22. A primary winding P is wrapped at the middle of the winding core 221. A first secondary winding S1a and a second secondary winding S2a are wrapped on two sides of the primary winding P, respectively. A first magnetic circuit M1a and a second magnetic circuit M2a are formed by the primary winding P with the first secondary winding S1a and the second secondary winding S2a, respectively. A primary side and a secondary side of the high voltage transformer have a common magnetic circuit. Therefore, leakage inductance between the first secondary winding S1a and the second secondary winding S2a cannot be adjusted so that current flowing through the first secondary winding S1a and the second secondary winding S2a cannot be balanced.

Therefore, a need exists in the industry to overcome the described limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic diagram of a first embodiment of a first winding method of a high voltage transformer in accordance with the present disclosure.

FIG. 2 is a schematic diagram of the first embodiment of a second winding method of the high voltage transformer in accordance with the present disclosure.

FIG. 3 is a schematic diagram of a plurality of embodiments of a first core of the high voltage transformer in accordance with the present disclosure.

FIG. 4 is a schematic diagram of a second embodiment of the high voltage transformer in accordance with the present disclosure.

FIG. 5 is a schematic diagram of a commonly used high voltage transformer.

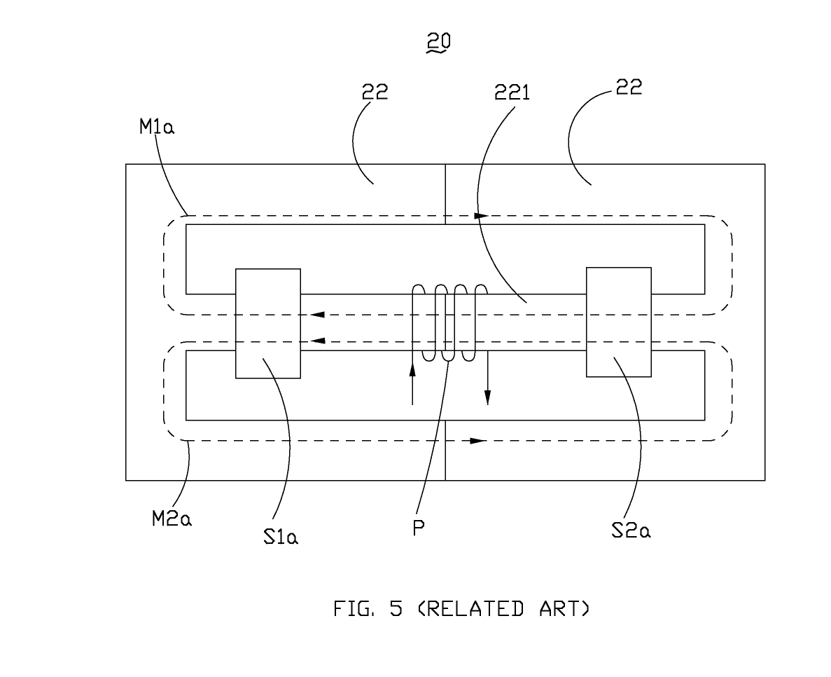

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In all embodiments of the disclosure, cores are accepted in bobbins (not shown) of transformers, and primary windings and secondary windings are applied on corresponding regions of the bobbins. For simplicity of descriptions, the bobbins are omitted, and the primary and secondary windings are described as applied to the cores directly. It should be noted that in practical application, one or more bobbins would be configured between the cores and the windings.

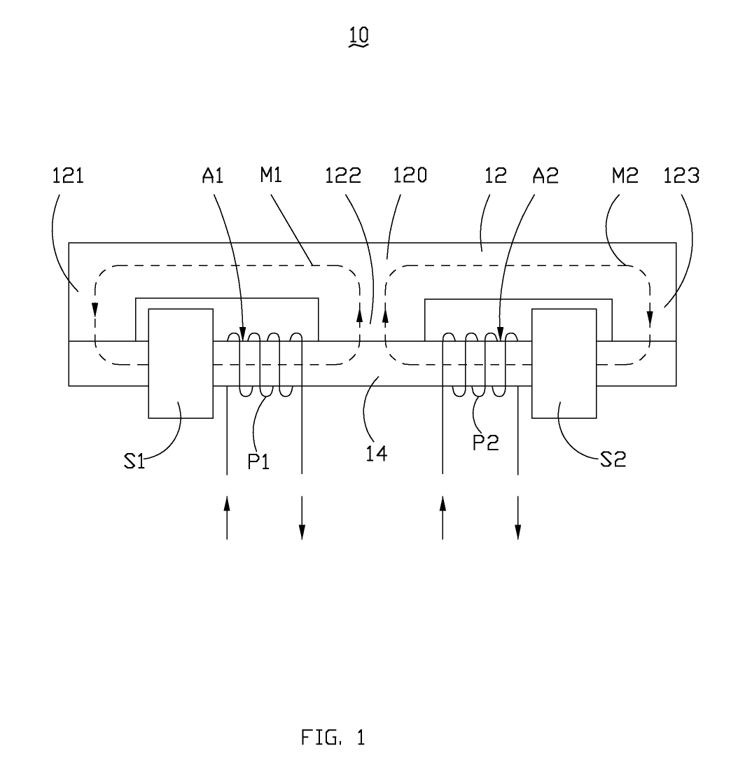

Referring to FIG. 1, a transformer 10 comprises a first core 12 and a second core 14 coupled to the first core 12. In the illustrated embodiment, the first core 12 is an “E” type core and the second core 14 is an “I” type core. In this embodiment, conductive coefficient of the first core 12 is at least 100 times greater than that of the second core 14. For example, the first core 11 could be made of a manganese-zinc (MZ) alloy, and the second core 12 could be made of a nickel-zinc (NZ) alloy, so as to achieve the conductive coefficient requirement.

In the illustrated embodiment, the first core 12 comprises a body portion 120, a first side portion 121, a second side portion 123 and a protruding portion 122. The first side portion 121 and the second side portion 123 are respectively configured on two opposite ends of the body portion 120, and the protruding portion 122 is disposed between the first side portion 121 and the second side portion 123, and at a substantial center of the body portion 120. In the embodiment, the body portion 120, the first side portion 121, the second side portion 123 and the protruding portion 122 collectively form an “E” shape. As stated above, the second core 14 is an “I” type core, in assembly, the first core 12 and the second core 14 collectively form a “ [symbol] ” type core assembly.

In the embodiment, the “ [symbol] ” type core comprises a first winding portion A1 and a second winding portion A2, as illustrated in FIG. 1. The first winding portion A1 is one portion of the second core 14 between the first side portion 121 and the protruding portion 122, and is wrapped by a first primary winding P1 and a first secondary winding S1. The second winding portion A2 is a portion of the second core 14 that is between the protruding portion 122 and the second side portion 123, and is wrapped by a second primary winding P2 and a second secondary winding S2. In this way, the first winding portion A1, the first side portion 121, the body portion 120 and the protruding portion 122 collectively define a first magnetic circuit M1, and the second winding portion A2, protruding portion 122, the body portion 120 and the second side portion 123 collectively define a second magnetic circuit M2. Direction of the first magnetic circuit M1 is reversed to that of the second magnetic circuit M2. For example, as illustrated in FIG. 1, the direction of the first magnetic circuit M1 is anti-clockwise, and the direction of the second magnetic circuit M2 is clockwise.

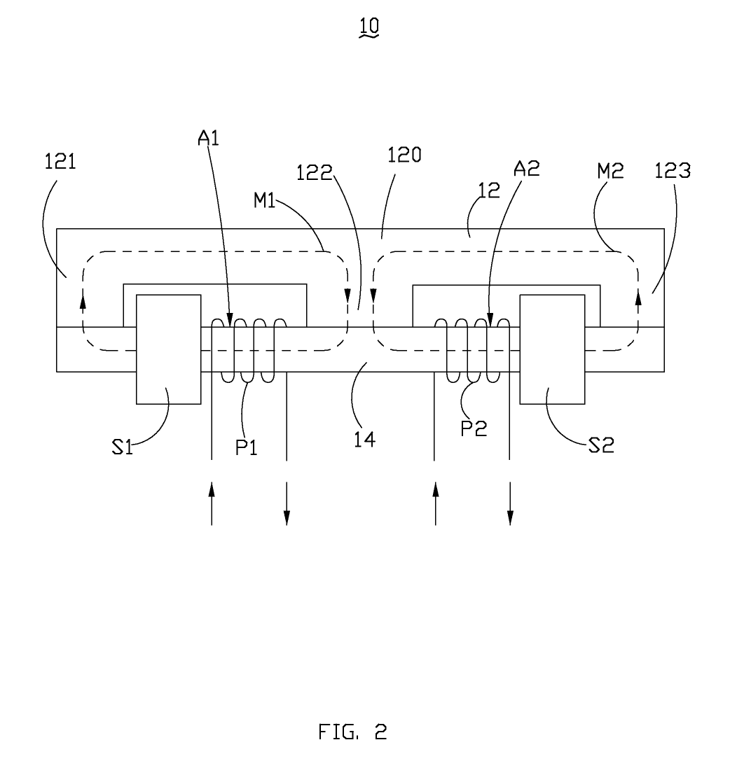

Winding direction of the first primary winding P1 is anti-clockwise and winding direction of the second primary winding P2 is clockwise, and this state is defined as a first winding method, as shown in FIG. 1. Referring to FIG. 2, the winding direction of the first primary winding P1 is clockwise and the winding direction of the second primary winding P2 is anti-clockwise, and this state is defined as a second winding method. In the second winding method, the direction of the first magnetic circuit M1 is clockwise, and the direction of the second magnetic circuit M2 is anti-clockwise.

Width of the protruding portion 122 of the first core 12 is adjustable to achieve different leakage inductances between the first secondary winding S1 and the second secondary winding S2, so as to balance current flowing through the first secondary winding S1 and the second secondary winding S2.

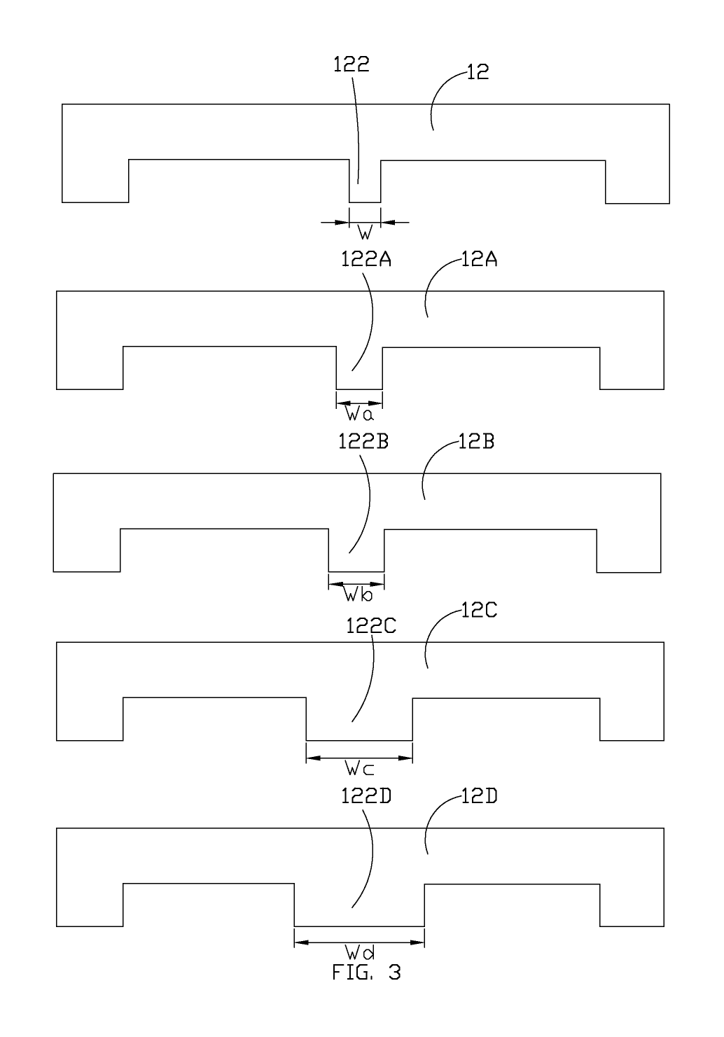

Referring to FIG. 3, the first core 12, 12A, 12B, 12C and 12D comprise the protruding portion 122, 122A, 122B,122C and 122D with widths of W, Wa, Wb, Wc and Wd, respectively. W, Wa, Wb, Wc and Wd are increased from small to large in order. Therefore, the protruding portion 122, 122A, 122B,122C and 122D can adjust the first magnetic circuit M1 and the second magnetic circuit M2 of the high voltage transformer 10, and also can change the leakage inductance between the first secondary winding S1 and the second secondary winding S2. With the width of the protruding portion 122 being increased, the leakage inductance between the first secondary winding S1 and the second secondary winding S2 can be increased. For example, the leakage inductance between the first secondary winding S1 and the second secondary winding S2 of the first core 12D is larger than that of the first core 12C, the leakage inductance of the first core 12C is larger than that of the first core 12B, similarly, the leakage inductance of the first core 12B is larger than that of the first core 12A and the leakage inductance of the first core 12A is larger than that of the first core 12.

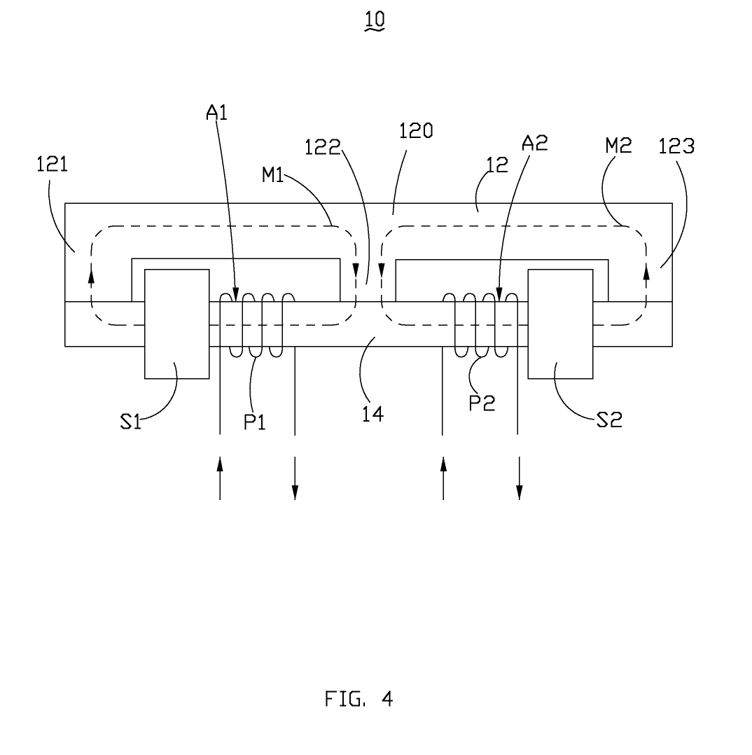

Referring to FIG. 4, the protruding portion 122 of the first core 12 has a smaller width, comparing with that the protruding portion 122 of the first core 12 as shown in FIG. 1 and FIG. 2.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A high voltage transformer, comprising:
a first core; and
a second core coupled to the first core;
wherein the first core comprises a body portion, a first side portion, a second side portion and a protruding portion disposed between the first side portion and the second side portion and at a substantial center of the body portion, the first side portion and the second side portion are respectively configured on two opposite ends of the body portion, the protruding portion isolates the second core into a first winding portion between the protruding portion and the first side portion and a second winding portion between the protruding portion and the second side portion, the first winding portion is wrapped by a first primary winding and a first secondary winding, and the second winding portion is wrapped by a second primary winding and a second secondary winding, the first winding portion, the first side portion, the body portion and the protruding portion collectively define a first magnetic circuit, the second winding portion, the protruding portion, the body portion and the second side portion collectively define a second magnetic circuit, direction of the first magnetic circuit is reversed to that of the second magnetic circuit; and
wherein width of the protruding portion of the first core is adjustable to achieve different leakage inductances between the first secondary winding and the second secondary winding, so as to balance current flowing through the first secondary winding and the second secondary winding.

2. The high voltage transformer as claimed in claim 1, wherein the first core is an “E” type core and the second core is an “I” type core, the first core and the second core collectively form a “ [symbol] ” type core assembly.

3. The high voltage transformer as claimed in claim 2, wherein conductive coefficient of the first core is at least 100 times greater than that of the second core.

4. The high voltage transformer as claimed in claim 3, wherein the first core is made of a manganese-zinc alloy, and the second core is made of a nickel-zinc alloy.

5. The high voltage transformer as claimed in claim 4, wherein winding direction of the first primary winding is anti-clockwise and winding direction of the second primary winding is clockwise.

6. The high voltage transformer as claimed in claim 5, wherein the direction of the first magnetic circuit is anti-clockwise, and the direction of the second magnetic circuit is clockwise.

7. The high voltage transformer as claimed in claim 4, wherein the winding direction of the first primary winding is clockwise and the winding direction of the second primary winding is anti-clockwise.

8. The high voltage transformer as claimed in claim 7, wherein the direction of the first magnetic circuit is clockwise, and the direction of the second magnetic circuit is anti-clockwise.
